(19) United States
(12) Patent Application Publication
(10) Pub. No.: US 2024/0258859 A1
(43) Pub. Date: Aug. 1, 2024

(54) STATOR FOR AN AXIAL FLUX MACHINE, AND AXIAL FLUX MACHINE

(71) Applicant: Schaeffler Technologies AG & Co. KG, Herozenaurach (DE)

(72) Inventors: Jorg Kegeler, Schleusingen (DE); Sandro Schilling, Suhl (DE)

(73) Assignee: Schaeffler Technologies AG & Co. KG, Herozenaurach (DE)

(21) Appl. No.: 18/565,681

(22) PCT Filed: May 9, 2022
(86) PCT No.: PCT/DE2022/100351

§ 371 Date: Nov. 30, 2023

(30) Foreign Application Priority Data
Jun. 1, 2021 (DE) 10 2021 114 131.1

(51) Int. Cl. H02K 3/26

(52) U.S. Cl. CPC H02K 3/26; H02K 2203/03

(57) ABSTRACT

A stator for an axial flux machine including a disc-shaped multilayer printed circuit board with a plurality of layers stacked one over the other. Each layer includes an electrically insulating substrate and at least one first conductor path which is applied onto the substrate and/or is introduced into the substrate. The at least one first conductor path forms a first winding, and a second conductor path forms second a winding. The layers can be electrically contacted with each other by means of vias running perpendicularly to a disc-shaped plane, wherein conductor paths connected together via the layers form a stator winding, and each pair of adjacent windings in a circumferential direction are connected together in a common layer. A first via is provided for a first winding end of the first winding, and a second via is provided for a second winding end of the second winding.

### CROSS-REFERENCE TO RELATED APPLICATIONS

This application is the U.S. National Phase of PCT Appln. No. PCT/DE2022/100351, filed May 9, 2022, which claims the benefit of German Patent Appln. No. 102021114131.1, filed Jun. 1, 2021, the entire disclosures of which are incorporated by reference herein.

### TECHNICAL FIELD

The present disclosure relates to a stator for an axial flux machine comprising a disc-shaped multilayer printed circuit board having a plurality of layers stacked one on top of the other, wherein each layer comprises an electrically insulating substrate and at least one first conductor path applied onto and/or introduced into the substrate, wherein at least the first conductor path forms a winding and a second conductor path forms a second winding, and the layers can be electrically contacted with one another via vias running perpendicular to the disc-shaped plane, wherein the conductor paths connected via the layers form the stator winding. The disclosure further relates to an axial flow machine.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort to which they are accustomed.

A detailed description of an electric drive can be found in an article in the ATZ magazine, Volume 113, May 2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which comprises an electric motor that is arranged to be concentric and coaxial having a bevel gear differential, wherein a shiftable 2-speed planetary gear set is arranged in the drive train between the electric motor and the bevel gear differential, which is also positioned to be coaxial to the electric motor or the bevel gear differential or spur gear differential. The drive unit is very compact and allows for a good compromise between climbing ability, acceleration, and energy consumption due to the switchable 2-speed planetary gear set. Such drive units are also referred to as e-axles or electrically operable drive trains.

In addition to purely electrically operated drive trains, hybrid drive trains are also known. Such drive trains of a hybrid vehicle usually comprise a combination of an internal combustion engine and an electric motor, and enable—for example in urban areas—a purely electric mode of operation with both sufficient range and availability, in particular when driving cross-country. In addition, there is the possibility of driving the internal combustion engine and the electric motor at the same time in certain operating situations.

An axial flux machine is a dynamo-electric machine in which the magnetic flux between the rotor and stator runs parallel to the axis of rotation of the rotor. Often, both the stator and the rotor are designed to be largely in the shape of a disc. Axial flux machines are particularly advantageous when the available axial installation space is limited in a given application. This is often the case, for example, with the electric drive systems for both electric or hybrid vehicles described at the outset.

In addition to the shortened axial installation length, a further advantage of the axial flux machine is its comparatively high torque density. The reason for this is, compared to radial flux machines, the larger air gap area which is available for a given installation space. Furthermore, a lower iron volume is required compared to conventional machines, which has a positive effect on the efficiency of the machine.

Typically, an axial flux machine comprises at least one stator having windings for generating the axially aligned magnetic field. At least one rotor is equipped with permanent magnets, for example, the magnetic field of which interacts with the magnetic field of the stator windings to generate a drive torque over an air gap.

It is generally known to design such stators for axial flux machines having a multilayer printed circuit board. A multilayer printed circuit board or multiple-layer printed circuit board is a circuit board that has several levels one above the other, each of which is equipped with conductor paths. The conductor paths arranged on the different levels can be electrically connected to one another via what are termed vias. These vias, also known as electrical vias, are usually realized by a vertical hole that is metallized on its inner diameter.

For example, a stator for an axial flux machine is known from EP 2863524 A1, which is designed in the form of a printed circuit board (PCB). The PCB is designed as a multilayer printed circuit board, i.e., it comprises several layers having conductor paths on top of one another. This allows the windings of a coil to be distributed over these multiple layers. It is also known from this publication that one turn of a winding can extend to several layers of the multilayer printed circuit board.

To achieve a high power density within such a multilayer printed circuit board, the largest possible copper content must be achieved. When producing multilayer printed circuit boards, individual layers are usually produced first in which conductor paths made of copper are applied to a PCB substrate, such as FR4. Several of these layers are then stacked on top of each other, wherein each is separated one from another by one or two sheets of prepreg. The entire stack is then laminated, creating a mechanical connection between the individual layers.

### SUMMARY

The object of the disclosure is to further optimize the power density of a stator having such a multilayer printed circuit board.

This object is achieved by a stator for an axial flux machine comprising a disc-shaped multilayer printed circuit board having a plurality of layers stacked one on top of the other, wherein each layer comprises an electrically insulating substrate and at least one first conductor path is applied onto and/or introduced into the substrate, and wherein the at least first conductor path forms a first winding and a second conductor path forms a second winding, and the layers can be electrically contacted with one another via vias running perpendicular to the disc-shaped plane, wherein the conductor paths connected via the layers form the stator winding, wherein two windings adjacent in the circumferential direction are connected to one another in a common layer, and a first via is provided for a first winding end of the first winding and a second via is provided for a second winding end of the second winding.

The object of the disclosure is further achieved by a stator for a linear motor comprising a rectangular multilayer printed circuit board having a plurality of layers stacked one on top of the other, wherein each layer comprises an electrically insulating substrate and at least one first, substrate applied onto and/or introduced into the conductor path, and wherein the at least first conductor path forms a first winding and a second conductor path forms a second winding, and the layers can be electrically contacted with one another via vias running perpendicular to the rectangular plane, wherein the conductor paths connected via the layers form the stator winding, two adjacent windings in a common layer are connected to one another, and a first via is provided for a first winding end of the first winding and a second via is provided for a second winding end of the second winding.

This achieves the advantage that the areas required for the vias within the multilayer printed circuit board can be significantly reduced and thus the copper content and the power density of the axial flux machine operated with a stator according to the disclosure can be increased. The reduction in the number of vias in the stator according to the disclosure occurs in that two windings are connected to one another in one plane of a layer, and only one via is needed for these two windings to connect them to another layer. In other words, this means that twice as many vias are needed to connect each individual winding.

First, the individual elements of the claimed subject matter of the disclosure are explained in the order in which they are named in the claims, and particularly preferred embodiments of the subject matter of the disclosure are described below.

The magnetic flux in an electric axial flux machine (AFM) according to the disclosure is directed axially to a direction of rotation of the rotor of the axial flux machine in the air gap between the stator and the rotor.

Various types of axial flux machines exist. One known type is what is termed an I arrangement, in which the rotor is arranged so as to be axially adjacent to a stator or between two stators and which is claimed in claim 1.

Another known type is what is termed an H arrangement, in which two rotors are arranged on opposite axial sides of a stator, and which is claimed in the coordinate independent claim 2.

In principle, it is also possible for a plurality of rotor-stator configurations to be arranged axially adjacent as an I-type and/or H-type. It would also be possible in this context to arrange both one or more I-type rotor-stator configurations and one or more H-type rotor-stator configurations to be adjacent to one another in the axial direction. In particular, it is also preferable that the rotor-stator configurations of the H-type and/or the I-type are each designed essentially identically, so that they can be assembled in a modular manner to form an overall configuration. Such rotor-stator configurations can in particular be arranged to be coaxial to one another and can be connected to a common rotor shaft or to a plurality of rotor shafts.

The rotor of an electric axial flux machine can preferably be designed at least in parts as a laminated rotor. A laminated rotor is designed to be layered in the axial direction. Alternatively, the rotor of an axial flux machine can also have a rotor carrier or rotor body which is correspondingly equipped with magnetic sheets and/or SMC material and with magnetic elements designed as permanent magnets.

In a preferred manner, a rotor body has an inner part via which the rotor can be connected to a shaft in a non-rotatable manner, and an outer part which delimits the rotor in a radially outward direction. The rotor body can be formed between the inner part and the outer part with several rotor struts, via which the inner part and the outer part are connected to one another and which, together with the radial outer surface of the inner part and the radial inner surface of the outer part, forms a receiving space for receiving the magnetic elements and the flux conducting elements of the rotor. As an alternative to the receiving space, the magnetic elements can be arranged or placed on the rotor carrier.

A magnetic element can be formed as a permanent magnet in the form of a bar magnet or in the form of smaller magnet blocks. The magnetic elements are usually arranged in, at, or on a rotor carrier. The magnetic element of a rotor of an axial flux machine, which is designed as a permanent magnet, interacts with a rotating magnetic field generated by the stator winding coils, which are usually supplied with a three-phase current.

A rotor shaft is a rotatably mounted shaft of an electric machine to which the rotor or rotor body is coupled in a non-rotatable manner.

The stator of an electric axial flux machine preferably has a stator body having a plurality of stator windings arranged in the circumferential direction. The stator body can be designed to be in one piece or segmented, as seen in the circumferential direction.

A further possible embodiment is to design the stator body as a sandwich of several multilayer printed circuit boards. The substrate of the multilayer printed circuit board is preferably formed from a composite of epoxy resin and glass fiber.

In a likewise preferred embodiment variant of the disclosure, it can also be provided that the stator is accommodated in the motor housing in a rotationally fixed manner and is connected thereto. According to a further embodiment of the subject matter of the disclosure to be preferred, the motor housing can be formed from a metallic material and/or ceramic and/or a plastic and/or a composite material.

Furthermore, according to an equally advantageous embodiment of the disclosure, it can be provided that the return cores are formed from a soft magnetic composite material. In particular, the return cores can be formed with an annular body, from which the return cores protrude in the axial direction, so that a crown-like spatial shape results. The return cores and the annular body are preferably monolithically shaped.

The stator according to the disclosure is intended in particular for use in an axial flux machine. In particular, the electric machine is dimensioned such that vehicle speeds of more than 50 km/h, preferably more than 80 km/h, and in particular more than 100 km/h can be achieved. The electrical machine particularly preferably has an output of more than 30 kW, preferably more than 50 kW, and in particular more than 70 kW. Furthermore, it is preferred that the electric machine provides speeds greater than 5,000 rpm, particularly preferably greater than 10,000 rpm, very particularly preferably greater than 12,500 rpm. For the purposes of this application, motor vehicles are land vehicles that are moved by machine power without being restricted to railroad tracks. A motor vehicle can be selected, for example, from the group of passenger cars, trucks, small motorcycles, light motor vehicles, motorcycles, motor buses/coaches or tractors.

The stator can particularly preferably also be coupled to a control unit. The control unit can particularly preferably comprise a power electronics module. The power electronics module is preferably a combination of different components that control or regulate a current to the electric machine of the final drive train, preferably including the peripheral components required for this purpose, such as cooling elements or power supply units. In particular, the power electronics module contains one or more power electronics components that are configured to control or regulate a current. This is particularly preferably one or more power switches, such as power transistors. The power electronics particularly preferably has more than two, particularly preferably three, phases or current paths which are separate from one another and each have at least one separate power electronics component. The power electronics is preferably designed to control or regulate a power per phase with a peak power, preferably continuous power, of at least 10 W, preferably at least 100 W, particularly preferably at least 1000 W.

According to an advantageous embodiment of the disclosure, it can be provided that the two windings adjacent in the circumferential direction are designed to be mirror-symmetrical along a radial plane.

According to a further preferred embodiment of the disclosure, it is preferred that the disc-shaped multilayer printed circuit board has a circular ring shape, particularly for axial flow machines designed as rotating machines.

It is further preferred that the stator for an axial flux machine has a disc-shaped multilayer printed circuit board having a plurality of layers stacked one on top of the other, wherein each layer comprises an electrically insulating substrate and at least one first conductor path applied onto and/or introduced into the substrate, and the multilayer printed circuit board has a plurality of openings distributed over its circumference for the passage of a magnetic return core, wherein the at least first conductor path forms a winding around a first of the openings and a second conductor path forms a second winding around a second of the openings, and the layers perpendicular to the disc-shaped plated vias can be electrically contacted with one another, wherein the conductor paths connected via the layers form the stator winding, wherein two windings adjacent in the circumferential direction are connected to one another in a common layer, and a first via for a first winding end of the first winding is provided in the area of first opening and a second via for a second winding end of the second winding is provided in the area of the second opening.

It is also preferred that the first winding has a clockwise winding direction opposite to the second winding.

According to a further preferred development of the disclosure, it can also be provided that the first via has essentially the same current-carrying cross-section as the conductor path of the first winding and/or the second via has essentially the same current-carrying cross-section as the conductor path of the second winding. This allows the power density of the stator to be further optimized. In this context it may also be preferred that first via has a current-carrying cross-section which corresponds to 0.5-0.94 times the current-carrying cross-section of the conductor path of the first winding and/or the second via has a current-carrying cross-section which corresponds to 0.5-0.94 times the current-carrying cross-section of the conductor path of the second winding. This also allows the power density of the stator to be optimized.

Furthermore, according to a likewise advantageous embodiment of the disclosure, it can be provided that the first via and/or the second via are cylindrical and/or cylindrical ring-shaped. The advantageous effect of this configuration is that the via can be produced by means of a bore.

According to a further particularly preferred embodiment of the disclosure, it can be provided that the first winding completely wraps around the first opening at least twice and/or the second winding completely wraps around the second opening at least twice. The number of times the winding is wrapped can also be used to adjust the current and voltage as well as the speed of the axial flux machine.

Furthermore, the disclosure can also be further developed such that the first opening and/or the second opening are/is designed to be trapezoidal, wherein the short side of the essentially parallel sides is arranged to be radially inwards

In a likewise preferred embodiment variant of the disclosure, it can also be provided that two adjacent windings are connected to one another in a common layer, wherein a plurality of layers designed in this way is arranged directly one above the other in the stator. This can ensure that the effective conductor cross-section is increased when these layers are connected in parallel and the effective number of windings is increased when connected in series. In each of these cases, the amount of copper used in the stator is increased.

It can also be advantageous to further develop the disclosure in such a way that the first via is arranged to be radially below the first opening and/or the second via is arranged to be radially below the second opening. The advantage that can be achieved in this way is that the vias do not take up any space in the important between-teeth area.

The object of the disclosure is further achieved by an axial flux machine for a drive train of a hybrid or fully electric motor vehicle, wherein the axial flux machine comprises a stator according to one of claims 1-8.

The disclosure will be explained in more detail below with reference to figures without limiting the general concept of the disclosure.

### BRIEF DESCRIPTION OF THE DRAWINGS

In the figures:

FIG. 1 shows an axial flux machine in a perspective exploded view,

FIG. 2 shows a top view of a first layer of a multilayer printed circuit board,

FIG. 3 shows a top view of a second layer of a multilayer printed circuit board,

FIG. 4 shows a top view of a third layer of a multilayer printed circuit board, and

FIG. 5 shows a top view of a fourth layer of a multilayer printed circuit board.

### DETAILED DESCRIPTION

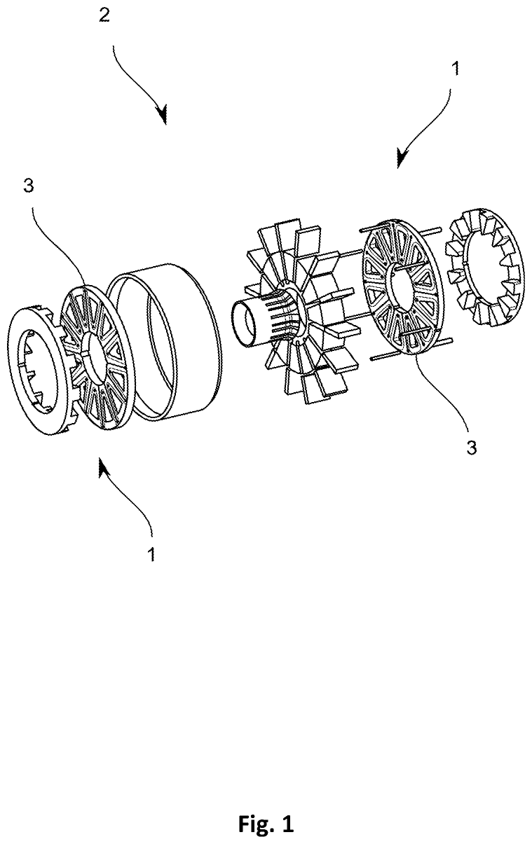

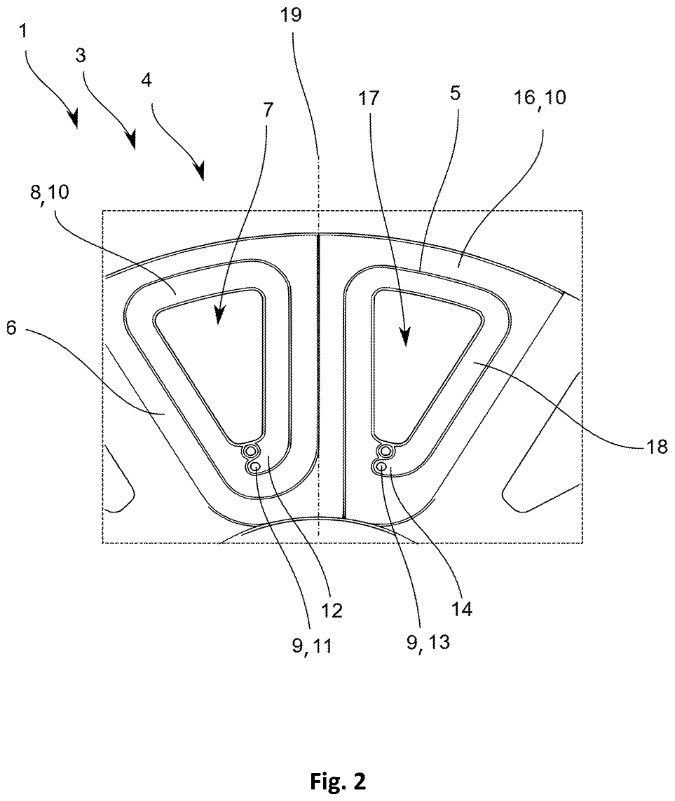

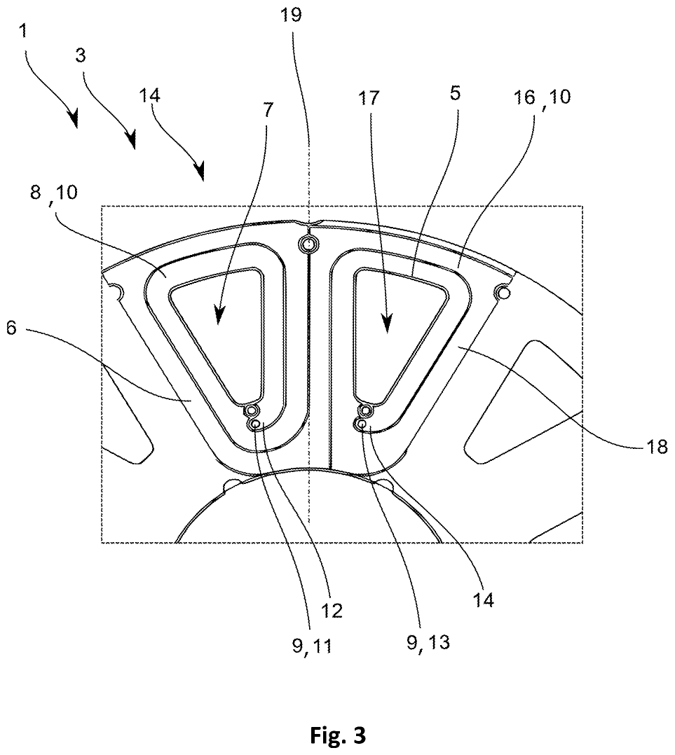

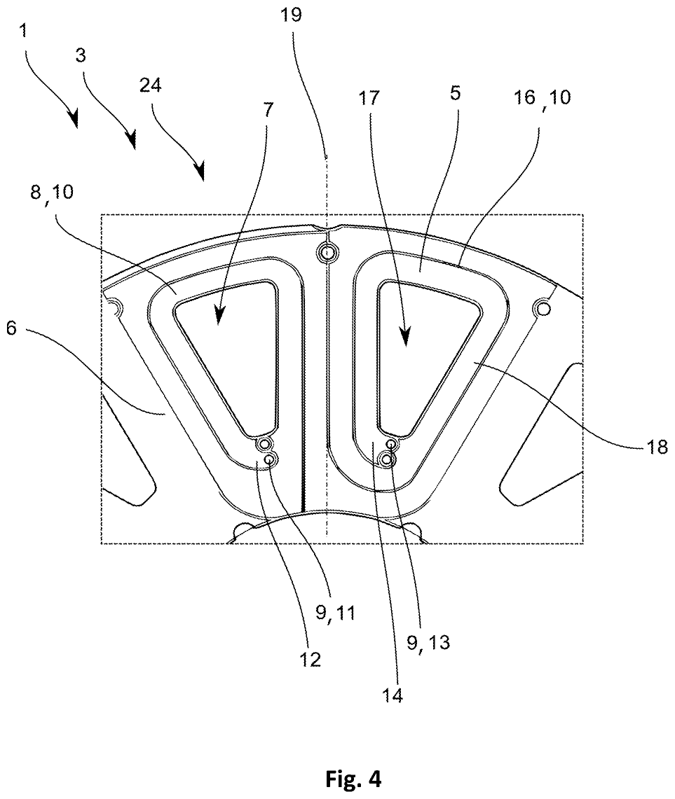

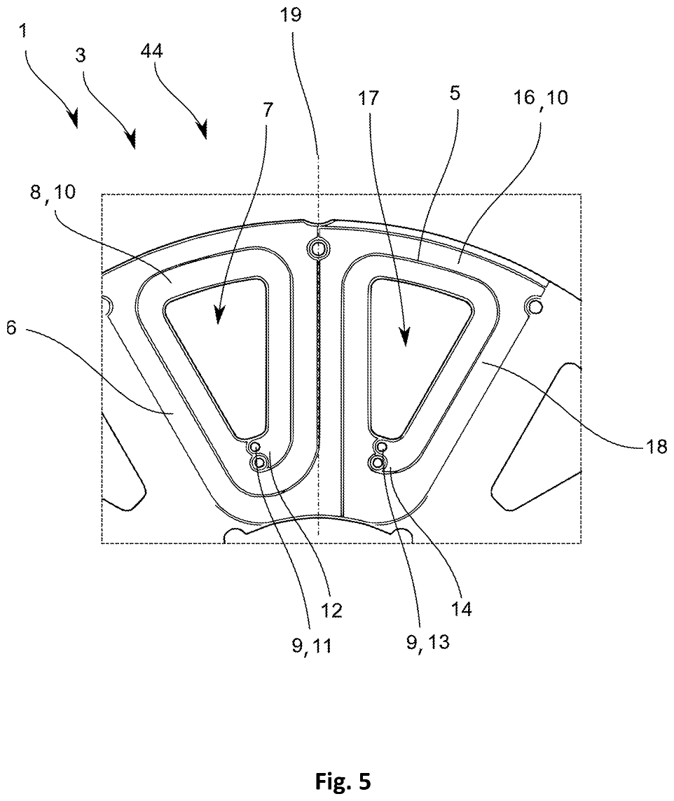

FIG. 1 shows a stator 1 for an axial flux machine 2 comprising an annular disc-shaped multilayer printed circuit board 3 having a plurality of layers 4, 24, 34, 44 stacked one above the other, as shown in FIGS. 2-5 and explained in more detail below. The multilayer printed circuit board 3 has a plurality of openings 7 distributed over its circumference for a magnetic return core to pass through.

Each of the layers 4, 24, 34, 44 of the multilayer printed circuit board 3 has an electrically insulating substrate 5 and at least one first conductor path 6 applied to the substrate 5. As can be clearly seen from FIGS. 2-5, the at least first conductor path 6 forms a winding 8 around a first of the openings 7, and a second conductor path 16 forms a second winding 18 around a second of the openings 17, wherein the conductor paths 6, 16 interconnected via layers 4, 24, 34, 44 form the stator winding 10. The first opening 7 and the second opening 17 are trapezoidal, wherein the short side of the essentially parallel sides is arranged to be radially inwards.

The layers 4, 24, 34, 44 can be electrically contacted with one another via vias 9 running perpendicular to the disc-shaped plane. Two windings 8, 18 that are adjacent in the circumferential direction are connected to one another in a common layer 4, 24, 34, 44. A first via 11 is provided for a first winding end 12 of the first winding 8 in the area of the first opening 7 and a second via 13 is provided for a second winding end 14 of the second winding 18 in the area of the second opening 17. The first via 11 is arranged to be radially below the first opening 7 and the second via 13 is arranged to be radially below the second opening 17.

The first winding 8 has a clockwise winding direction opposite to that of the second winding 18.

The first via 11 particularly preferably has essentially the same current-carrying cross-section as the conductor path 6 of the first winding 8, and the second via 13 preferably has essentially the same current-carrying cross-section as the conductor path 6 of the second winding 18. The first via 11 and the second via 13 are cylindrical and/or cylindrical ring-shaped.

FIGS. 2-5 further show that the first winding 8 completely wraps around the first opening 7 and the second winding 18 completely wraps around the second opening 17 at least twice. What can also be seen from the synopsis of FIGS. 2-5 is that two adjacent windings 8, 18 are connected to one another in a common layer 4, wherein a plurality of layers 4, 24, 34, 44 designed in this way are arranged directly on top of one another the stator 1.

Even if not shown in the figures, it is still possible for the stator 1 to be designed without iron, i.e., without the openings 7.

Furthermore, it is also conceivable that the stator 1 is configured for a linear motor, wherein a rectangular multilayer printed circuit board 3 having a plurality of layers 4, 24, 34, 44 stacked one on top of the other is present. Each layer comprises an electrically insulating substrate 5 and at least one first conductor path 6 applied onto and/or introduced into the substrate 5. The at least first conductor path 6 forms a first winding 8 and a second conductor path 16 forms a second winding 18. The layers 4, 24, 34, 44 can be electrically contacted with one another via vias 9 running perpendicular to the rectangular plane, wherein the conductor paths 6, 16 interconnected via the layers 4, 24, 34, 44 form the stator winding 10 of the linear motor. Two adjacent windings 8, 18 are in a common layer 4, 24, 34, 44 connected with each other. A first via 11 is provided for a first winding end 12 of the first winding 8, and a second via 13 is provided for a second winding end 14 of the second winding 18.

The disclosure is not limited to the embodiments shown in the figures.

The above description is therefore not to be regarded as limiting, but rather as illustrative. The following claims are to be understood as meaning that a named feature is present in at least one embodiment of the disclosure. This does not exclude the presence of further features. If the patent claims and the above description define ‘first’ and ‘second’ features, this designation serves to distinguish between two features of the same type without defining an order of precedence.

### LIST OF REFERENCE SYMBOLS

1 Stator
2 Axial flux machine
3 Multilayer printed circuit board
4 Layer
5 Substrate
6 Conductor path
7 Openings
8 Winding
9 Vias
10 Stator winding
11 Via
12 Winding end
13 Via
14 Winding end
16 Conductor path
17 Openings
18 Winding
19 Radial plane
24 Layer
34 Layer
44 Layer

1. A stator for an axial flux machine comprising: a disc-shaped multilayer printed circuit board having a plurality of layers, each layer being an electrically insulating substrate and including at least one first conductor path forming a first winding, and a second conductor path forming a second winding, and the plurality of layers electrically contacted with one another via vias running perpendicular to a disc-shaped plane of the disc-shaped multilayer printed circuit board, the conductor paths interconnected via the plurality of layers forming a stator winding,
wherein
the first and second windings adjacent in a circumferential direction in a common layer are connected to each other, and a first via is provided for a first winding end of the first winding and a second via is provided for a second winding end of the second winding.

2. A stator for a linear motor comprising: a rectangular multilayer printed circuit board having a plurality of layers, each layer including an electrically insulating substrate and at least one first conductor path forming a first winding and a second conductor path forming a second winding, and the plurality of layers electrically contacted with one another via vias running perpendicular to a rectangular plane of the rectangular multilayer printed circuit, the conductor paths interconnected via the plurality of layers forming a stator winding,
wherein
two adjacent windings in a common layer are connected to each other and a first via is provided for a first winding end of the first winding and a second via is provided for a second winding end of the second winding.

3. The stator according to claim 1,
wherein
the multilayer printed circuit board has a plurality of openings distributed over its circumference for the passage of a magnetic return core, wherein the at least first conductor path has the first winding around a first opening and the second conductor path has the second winding around a second opening and the first via for the first winding end of the first winding is adjacent the first opening and the second via for the second winding end of the second winding is adjacent the second opening.

4. The stator according to claim 1,
wherein
the first winding has a clockwise winding direction opposite to that of the second winding.

5. The stator according to claim 1,
wherein
the first via has a current-carrying cross-section which corresponds to 0.5-0.94 times the current-carrying cross-section of the conductor path of the first winding or the second via has a current-carrying cross-section which corresponds to 0.5-0.94 times a current-carrying cross-section of the conductor path of the second winding.

6. The stator according to claim 1,
wherein at least one of
the first via or the second via is cylindrical and/or cylindrical ring-shaped.

7. The stator according to claim 3,
wherein
the first winding completely wraps around the first opening at least twice or the second winding completely wraps around the second opening at least twice.

8. The stator according to claim 3,
wherein at least one of
the first opening or the second opening is trapezoidal including two parallel sides, wherein a short side of the parallel sides arranged radially inwards.

9. The stator according to claim 1,
wherein
a plurality of layers are arranged directly one above the other in the stator.

10. The stator according to claim 9,
wherein
the first via is radially below the first opening or the second via is radially below the second opening.

11. The stator according to claim 2, wherein the multilayer printed circuit board has a plurality of openings distributed over its circumference for the passage of a magnetic return core, wherein the at least first conductor path has the first winding around a first opening and the second conductor path has the second winding around a second opening, and the first via for the first winding end of the first winding is adjacent the first opening and the second via for the second winding end of the second winding is adjacent the second opening.

12. The stator according to claim 2, wherein the first winding has a clockwise winding direction opposite to that of the second winding.

13. The stator according to claim 2, wherein the first via has a current-carrying cross-section which corresponds to 0.5-0.94 times the current-carrying cross-section of the conductor path of the first winding or the second via has a current-carrying cross-section which corresponds to 0.5-0.94 times a current-carrying cross-section of the conductor path of the second winding.

14. The stator according to claim 2, wherein at least one of the first via or the second via are cylindrical or cylindrical ring-shaped.

15. The stator according to claim 11, wherein the first winding completely wraps around the first opening at least twice or the second winding completely wraps around the second opening at least twice.

16. The stator according to claim 11, wherein at least one of the first opening or the second opening is trapezoidal including two parallel sides, wherein a short side of the parallel sides arranged radially inwards.

17. The stator according to claim 2, wherein a plurality of layers are arranged directly one above the other in the stator.

18. The stator according to claim 17, wherein the first via is radially below the first opening or the second via is radially below the second opening.
